(19) United States
(12) Patent Application Publication
(10) Pub. No.: US 2024/0173783 A1
(43) Pub. Date: May 30, 2024

(54) DUST CONTAINMENT DEVICE FOR A CHAINSAW

(71) Applicant: MILWAUKEE ELECTRIC TOOL CORPORATION, Brookfield, WI (US)

(72) Inventors: Ian H.A. Blair, Wauwatosa, WI (US); Julian L. Kinneavy, Sussex, WI (US)

(21) Appl. No.: 18/520,680

(22) Filed: Nov. 28, 2023

Related U.S. Application Data
(60) Provisional application No. 63/385,100, filed on Nov. 28, 2022.

(51) Int. Cl. B23D 59/00; B27B 17/02

(52) U.S. Cl. CPC B23D 59/006; B27B 17/02

(57) ABSTRACT

A chainsaw includes a housing, a guide bar coupled to the housing, a cutting chain disposed along the guide bar, a shroud coupled to the housing, and a connector configured to be coupled to the shroud. The cutting chain is configured to cut a workpiece and generate debris. A portion of the guide bar is disposed between the housing and the shroud. The connector is configured to receive the debris.

### CROSS-REFERENCE TO RELATED APPLICATION

This application claims priority to U.S. Provisional Patent Application No. 63/385,100, filed Nov. 28, 2022, the entire contents of which are incorporated herein by reference.

### FIELD OF THE INVENTION

The present disclosure relates to chainsaws. More specifically, the present disclosure relates to dust containment devices for use with chainsaws.

### SUMMARY

In one aspect, the disclosure provides a chainsaw including a housing, a guide bar coupled to the housing, a cutting chain disposed along the guide bar, a shroud coupled to the housing, and a connector configured to be coupled to the shroud. The cutting chain is configured to cut a workpiece and generate debris. A portion of the guide bar is disposed between the housing and the shroud. The connector is configured to receive the debris.

In another embodiment, the disclosure provides a chainsaw including a housing, a guide bar coupled to the housing, a cutting chain disposed along the guide bar, and a shroud coupled to the housing and including a debris port. The cutting chain is operable to cut a workpiece and generate debris. The debris port is configured to receive the debris.

In another embodiment, the disclosure provides a shroud for use with the chainsaw. The chainsaw includes a housing, a guide bar coupled to the housing, and a cutting chain disposed along the guide bar and operable to cut a workpiece and generate debris. The shroud includes an outer wall configured to be spaced apart from the housing of the chainsaw and cover a portion of the guide bar, a rear wall extending from the outer wall and configured to extend toward the housing, a bottom wall extending from the outer wall and configured to extend toward the housing, and a debris port extending outwardly from the outer wall. The debris port is configured to be coupled to a suction source.

Other aspects of the invention will become apparent by consideration of the detailed description and accompanying drawings.

### BRIEF DESCRIPTION OF THE DRAWINGS

FIG. 1 is a top perspective view of a chainsaw.

FIG. 2 is a side view of the chainsaw of FIG. 1 with a shroud removed.

FIG. 3 is a bottom perspective view of the chainsaw of FIG. 1.

FIG. 4 is a perspective view of a connector for use with a chainsaw.

FIG. 5 is a top view of the connector of FIG. 4.

FIG. 6 is a cross-sectional view taken along the line 6-6 in FIG. 5.

FIG. 7 is a side view of the chainsaw of FIG. 1 including the connector of FIG. 4.

FIG. 8 is a front view of a shroud for use with a chainsaw.

FIG. 9 is a rear view of the shroud of FIG. 8.

FIG. 10 is a side view of the chainsaw of FIG. 1 including the shroud of FIG. 8.

FIG. 11 is an exploded, front view of another shroud for use with a chainsaw.

FIG. 12 is an exploded, rear view of the shroud of FIG. 11.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

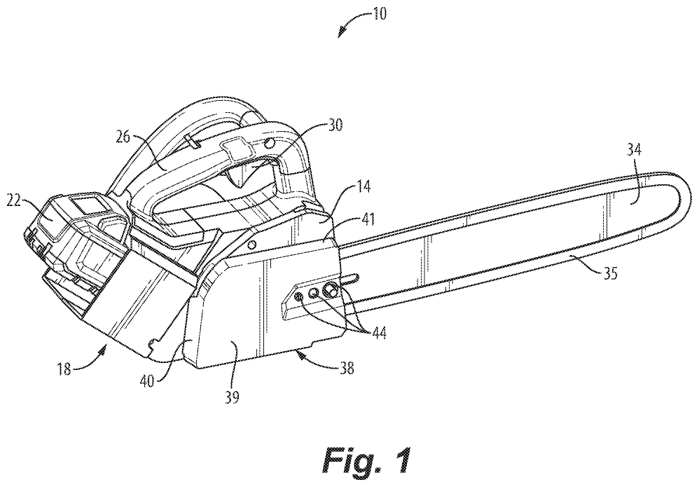

FIGS. 1-3 illustrate a chainsaw 10 configured to perform cutting operations on a workpiece. The chainsaw 10 includes a housing 14 configured to support a motor and a drive mechanism, a power receptacle 18 coupled to a rear portion of the housing 14, a power source 22 coupled to the power receptacle 18, a handle 26 coupled to the housing 14 and the power receptacle 18, a trigger 30 coupled to the handle 26, a guide bar 34 coupled to a front portion of the housing 14, and a shroud 38 coupled to a side portion of the housing 14. The illustrated chainsaw 10 is only one example of a chainsaw, and other chainsaws having other configurations or components are possible.

The illustrated shroud 38 includes an outer wall 39 and a rear wall 40 and a top wall 41 extending from the outer wall 39. The outer wall 39 includes a plurality of apertures 44. One of the plurality of apertures 44 may be configured to receive a fastener (e.g., a screw, a bolt, etc.) to couple the shroud 38 to the housing 14. Another of the plurality of apertures 44 may be configured as an oil or lubricant port. Yet another of the plurality of apertures 44 may be configured to be a vent or cooling port. The shroud 38 covers a drive gear 45 of the chainsaw 10 and a portion of the guide bar 34, such that during operation, debris (e.g., wood chips, saw dust, etc.) is initially contained within a cavity 50 of the chainsaw 10.

A chainsaw chain 35 is disposed along a periphery of the guide bar 34 and configured to be rotatably driven by the motor and the drive mechanism when the trigger 30 is moved from an OFF position to an ON position. As the chainsaw chain 35 is driven along the guide bar 34, a user is able to perform cutting operations on material such as wood. In the illustrated embodiment, the power source 22 is a battery pack, such as an 18 volt Li-ion battery pack. The battery pack is configured to selectively supply power to the motor to activate the chainsaw 10. In other embodiments, the chainsaw 10 may have a differently sized battery pack or have other types of power sources, such as a gasoline engine or an AC power cord.

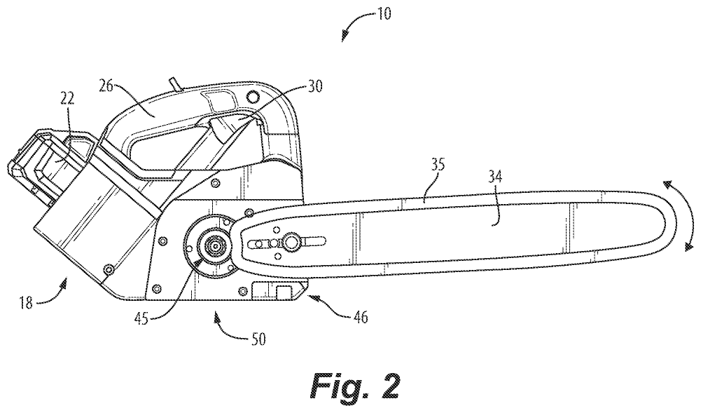

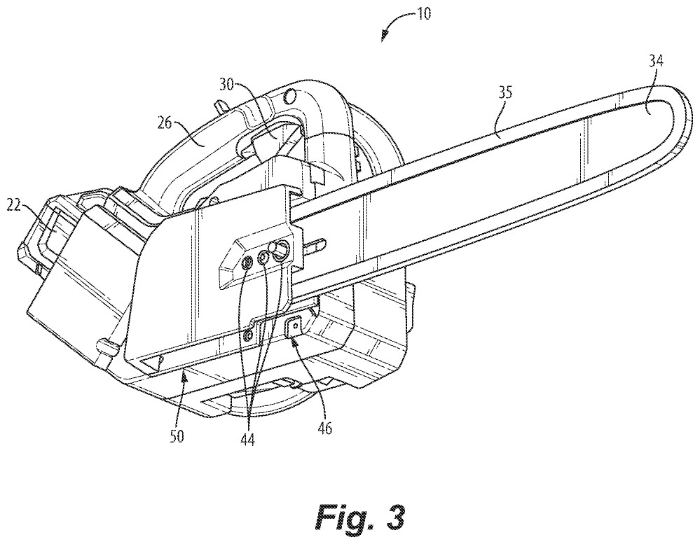

FIGS. 2-3 illustrate the cavity 50 of the chainsaw 10 disposed between the housing 14 and the shroud 38. While the chainsaw 10 is cutting a workpiece, the debris is produced or generated and enters the cavity 50. For example, if the chainsaw 10 is cutting a piece of wood, sawdust and wood chips may be produced and enter the cavity 50. A portion of the debris may get stuck or lodged in the cavity 50, and the rest of the debris may exit the cavity 50 through a chip ejection port 46 located at a bottom and a front portion of the cavity 50.

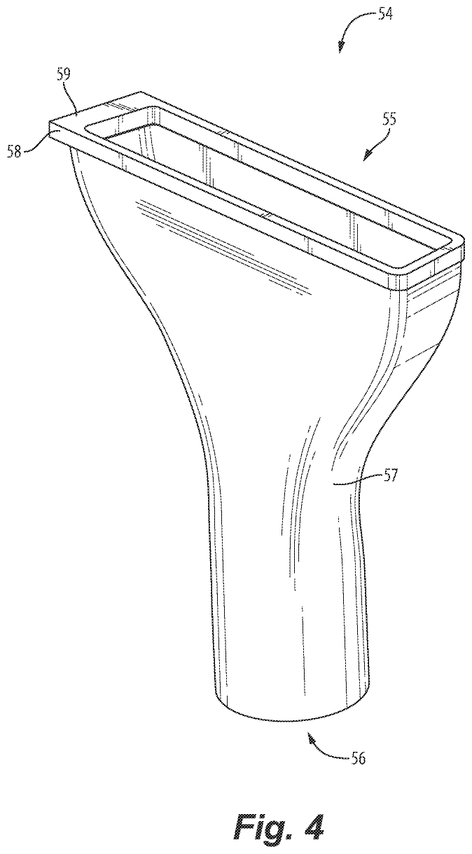

FIG. 4 illustrates a connector 54 to assist the removal of the debris from the cavity 50 (FIGS. 2 and 3). The connector 54 includes a first end 55 having a first opening and a second end 56 opposite the first end 55 and having a second opening. In the illustrated embodiment, the first opening is a polygonal (e.g., trapezoidal) opening, and the second opening is a circular opening. Similarly, the first end 55 has a polyhedron or polygonal shape, and the second end 56 has a cylindrical shape. In other embodiments, the first and second openings may have other shapes or configurations (e.g., rectangular, elliptical, etc.). The first opening of the first end 55 has a greater area than the second opening of the second end 56. Stated another way, the first opening defines a first area, and the second area defines a second area. The first area is greater than the second area. A neck 57 of the connector 54 guides debris from the first end 55 toward the second end 56, and gradually changes the shape of the connector 54 between the first and second ends 55, 56. The illustrated connector 54 is one piece. Alternatively, the connector 54 may be composed of multiple pieces coupled together.

The connector 54 is configured to be removably coupled to the shroud 38. In particular, the connector 54 is configured to be coupled to the chip ejection port 46 defined by the shroud 38. In some embodiments, the connector 54 is configured to be removably coupled to the shroud 38 and the housing 14. For example, the first end 55 of the connector 54 may be captured between the shroud 38 and the housing 14. The illustrated first end 55 includes a flange 58. The flange 58 extends outwardly from the first end 55 of the connector 54 and is received in the chip ejection port 46. The flange 58 engages a track or shoulder within the shroud 38 to releasably secure the connector 54 to the shroud 38. In the illustrated embodiment, the first end 55 of the connector 54 is slidably coupled to the chip ejection port 46. For example, the connector 54 may be slid from an open, forward end of the shroud 38 toward the rear wall 40 of the shroud 38 to couple the connector 54 to the shroud. In other embodiments, the locations of the flange 58 and the track or shoulder may be reversed. For example, the first end 55 of the connector 54 may include a track or shoulder that receives a flange extending from the shroud 38 adjacent the chip ejection port 46. In other embodiments, the connector 54 and/or the chip ejection port 46 may be coupled by magnets or clips on the connector 54 and/or the chip ejection port 46. In other embodiments, the connector 54 and chip ejection port 46 may be coupled by a snap fit or a press fit connection.

The second end 56 of the connector 54 is configured to be coupled to a suction source (e.g., a vacuum). The suction source provides a suction force on the second end 56, which operates to pull the debris from the cavity 50. More specifically, the suction force causes the debris to travel from the cavity 50 through the chip ejection port 46, into the first end 55, and out the second end 56. The suction source may be activated during operation of the chainsaw 10 to reduce build-up of debris within the cavity 50. Alternatively, the suction source may be deactivated during operation of the chainsaw 10 and activated when the chainsaw 10 is at rest to facilitate removal of debris build up within the cavity 50. In some embodiments, the second end 56 of the connector 54 may be coupled to a collection bag that does not include a suction source. During operation of the chainsaw 10, debris will enter the cavity 50 and travel through the chip ejection port 46, into the first end 55 of the connector 54, and out the second end 56 of the connector 54 into the collection bag.

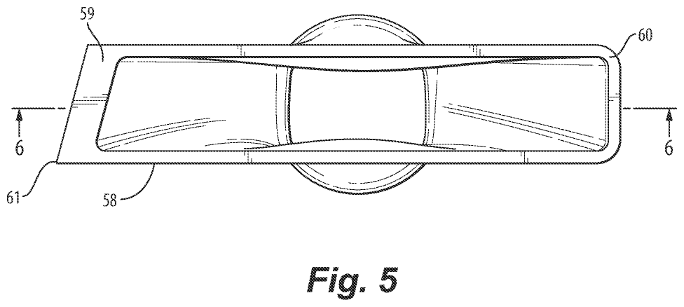

With reference to FIG. 5, the flange 58 has a pair of rounded corners 60 and a pair of sharp corners 61. The sharp corners 61 may be configured to match the shape of the chip ejection port 46 to provide a secure fit. In some embodiments, the sharp corners 61 may be configured to be received in a recess in a wall of the chip ejection port 46. In other embodiments, the flange 58 may have other configurations. When the illustrated connector 54 is coupled to the shroud 38, the sharp corners 61 are configured to be positioned adjacent the rear wall 40. As such, the rounded corners 60 are configured to be positioned furthest from the rear wall 40. Said another way, when the illustrated connector 54 is coupled to the shroud 38, the rounded corners 60 are configured to be positioned nearest the guide bar 34, and the sharp corners 61 are configured to be positioned furthest from the guide bar 34.

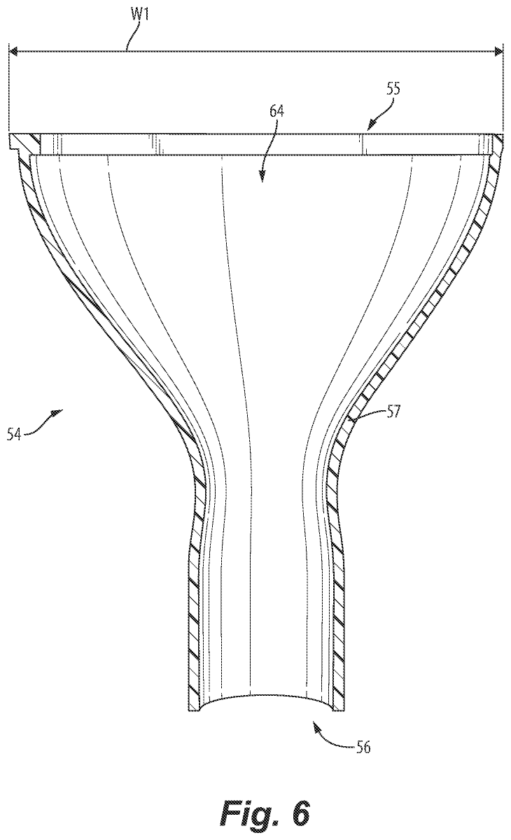

FIG. 6 illustrates a passageway 64 in the connector 54. The passageway 64 is defined between the first end 55 and the second end 56 and extends through the neck 57. Debris is directed through the passageway 64 from the first end 55 to the second end 56. The neck 57 is illustrated as having a curved shape. In some embodiments, the neck 57 may have a linear shape.

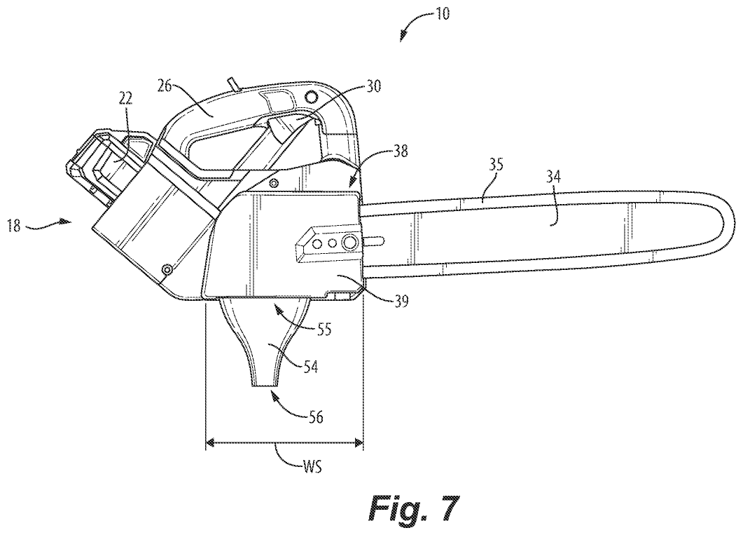

FIG. 7 illustrates the connector 54 coupled to the chainsaw 10. In the illustrated embodiment, the connector 54 has a width W1 (FIG. 6) at the first end 55 that is smaller than a width WS of the shroud 38. The width W1 is defined as the distance between the rounded corners 60 and the sharp corners 61, and the width WS is defined as the distance between a rear edge of the outer wall 39 (i.e., adjacent the rear wall 40 (FIG. 1)) and a front edge of the outer wall 39. In some embodiments, the width W1 of the first end 55 may be equal to or greater than the width WS of the shroud 38.

In some embodiments, the connector 54 may be coupled to the chainsaw 10, such that there is a minimal distance between the top surface 59 and the chainsaw chain 35. This configuration allows only a small percentage of debris to exit the cavity 50 between the top surface 59 and the chainsaw chain 35, and a large percentage of the debris to exit the cavity through the connector 54. In other embodiments, there may be a greater distance between the top surface 59 and the chainsaw chain 35 to allow a greater percentage of debris to exit the cavity 50 between the top surface 59 and the chainsaw chain 35.

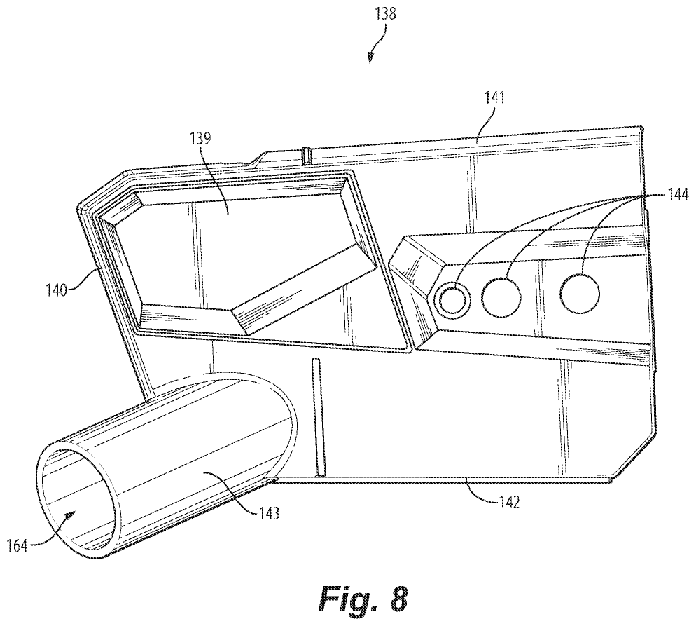

FIGS. 8-10 illustrate another shroud 138 for use with the chainsaw 10. Similar to the shroud 38 described above, the shroud 138 is couplable to a side portion of the housing 14 and covers the drive gear 45 and a portion of the guide bar 34. The illustrated shroud 138 includes an outer wall 139, a rear wall 140, a top wall 141, and a bottom wall 142. The rear wall 140, the top wall 141, and the bottom wall 142 extend from the outer wall 139 toward the chainsaw housing 14. The outer wall 139 includes a plurality of apertures 144 corresponding to fastener, lubrication, and/or venting ports of the chainsaw 10. The bottom wall 142 extends toward and engages an outer surface of the housing 14 of the chainsaw 10. Similarly, the rear wall 140 and the top wall 141 respectively engage the outer surface of the housing 14.

The illustrated shroud 138 also includes a debris port 143. The debris port 143 extends from the outer wall 139 in a direction away from the chainsaw housing 14. In the illustrated embodiment, the debris port 143 is integrally formed as a single piece with the remainder of the shroud 138. Stated another way, the debris port 143 and the remainder of the shroud 138 form a single, monolithic component. In some embodiments, the debris port 143 may be a separate piece that is coupled to a wall (e.g., the outer wall 139) of the shroud 138. In the illustrated embodiment, the debris port 143 extends obliquely from the outer wall 139 in a rearward direction and a downward direction. In other words, the debris port 143 extends away from the guide bar 34 and the handle 26. In some embodiments, the debris port 143 may extend in other directions. For example, the debris port 143 may extend perpendicularly from the outer wall 139. In the illustrated embodiment, the debris port 143 extends from a bottom rear corner of the shroud 138 (i.e., adjacent the rear wall 140 and the bottom wall 142). In other embodiments, the debris port 143 can extend from other portions of the shroud 138. Positioning the debris port 143 in the bottom rear corner of the shroud 138 and having the debris port 143 extend obliquely reduces interference of the debris port 143 (and a connected suction source or collection bag) with a work piece and/or user during operation of the chainsaw 10.

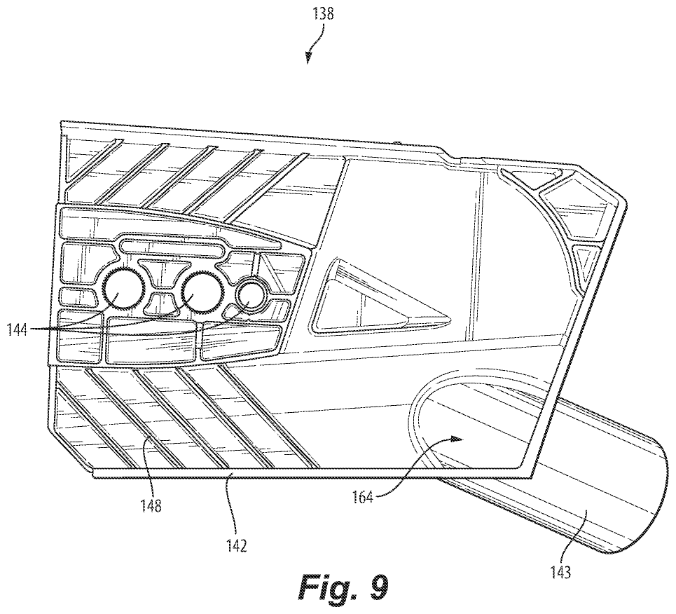

As shown in FIG. 9, the shroud 138 includes a plurality of ridges 148 extending from an inner surface of the outer wall 139 toward the chainsaw housing 14. The plurality of ridges 148 are configured to add structural support to the shroud 138. In some embodiments, the plurality of ridges 148 may be configured to help direct debris (e.g., toward the debris port 143). The debris port 143 defines a passageway 164 through which debris may pass out of the shroud 138. The debris port 143 is configured to be coupled to a suction source, a collection bag, or the like, similar to the second end 56 of the connector 54 described above.

The shroud 138 can be manufactured by additive manufacturing (e.g., 3-D printing), injection molding, machining, or the like. In some embodiments, the shroud 138 may be made of a polymer material. In other embodiments, the shroud 138 may be made of a metal material or a combination of materials. The surface of the shroud 138 is smooth to improve a flow of debris along the shroud 138. In some embodiments, a coating may be applied to the shroud 138 to improve the flow of debris along the shroud 138. The coating may be, for example, oil resistant.

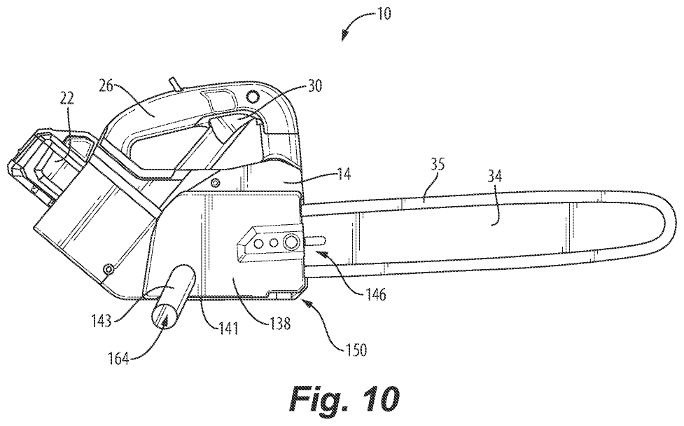

With specific reference to FIG. 10, the shroud 138 is coupled to the chainsaw 10. A cavity 150 is defined between the shroud 138 and the housing 14 of the chainsaw 10 (similar to the cavity 50). The rear wall 140, the top wall 141, and the bottom wall 142 abut the housing 14, such that a majority of the debris exits the cavity 150 through the debris port 143. In addition to the debris port 143, debris may exit the cavity 150 through a chip ejection port 146 located adjacent a front edge of the shroud 138 and the guide bar 34. In other embodiments, the shroud 138 may include a front wall (not shown) that extends from the outer wall 139 toward the housing 14 to further define the cavity 150. The front wall can abut or engage the housing 14 along with the rear, top, and bottom walls 140, 141, 142. The front wall may restrict debris from exiting the cavity 150 through the chip ejection port 146.

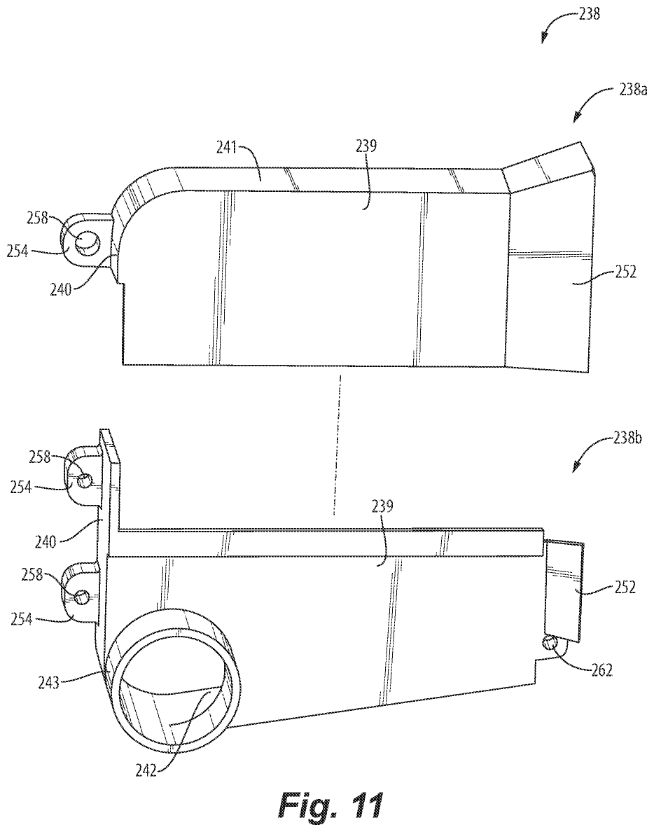

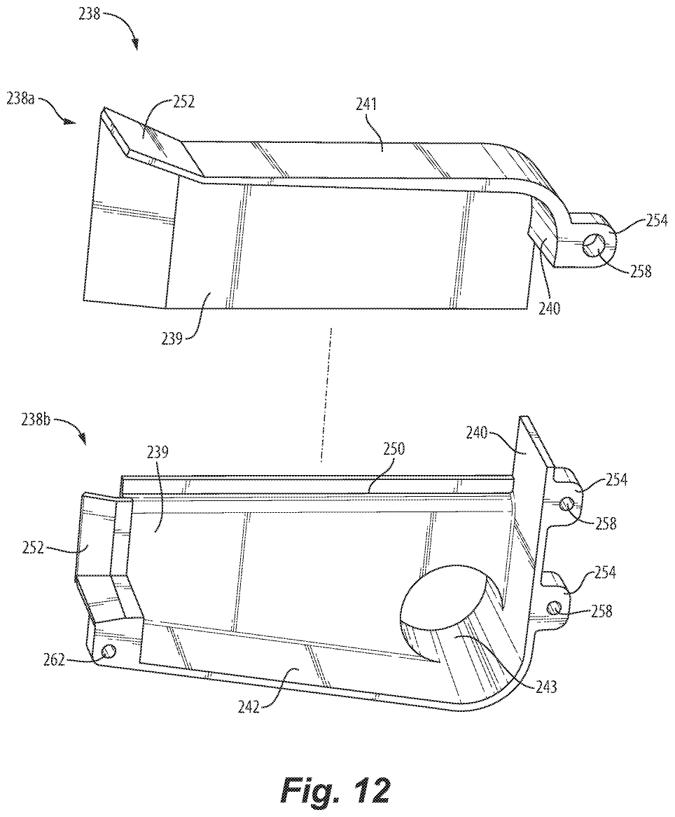

FIGS. 11 and 12 illustrate another shroud 238 for use with the chainsaw 10. Similar to the shrouds 38, 138 described above, the shroud 238 is couplable to a side portion of the housing 14 of the chainsaw 10 and covers the drive gear 45 and a portion of the guide bar 34. The shroud 238 includes a first portion 238a (also referred to as an upper portion 238a) and a second portion 238b (also referred to as a lower portion 238b). The upper portion 238a is received in a slot 250 of the lower portion 238b to connect the upper and lower portions 238a, 238b. In other embodiments, the lower portion 238b may be received in a slot in the upper portion 238a. In yet other embodiments, the upper and lower portions 238a, 238b may be coupled together by other suitable mechanisms (e.g., by a fastener, an adhesive, a snap fit connection, etc.). The upper and lower portions 238a, 238b together define an outer wall 239 and a rear wall 240. The upper portion 238a includes a top wall 241, and the lower portion 238b includes a bottom wall 242. The rear wall 240, top wall 241, and the bottom wall 242 extend from the outer wall 239 toward the housing 14 and are configured to engage the housing 14. The outer wall 239 includes a flange portion 252 on a side of the outer wall 239 opposite the rear wall 240. The flange portion 252 can, for example, increase a clearance between the chainsaw chain 35 and the shroud 238. The shroud 238 includes a plurality of brackets 254 on the rear wall 240. Each bracket 254, or boss, includes an aperture 258 configured to receive a fastener (e.g., a screw; bolt, etc.) to couple the shroud 238 to the housing 14. The illustrated shroud 238 includes one bracket 254 on the upper portion 238a and two brackets 254 on the lower portion 238b. In other embodiments, the shroud 238 may include fewer or more brackets and/or the brackets may be located elsewhere. The illustrated brackets 254 are integrally formed with the rear wall 240. Stated another way, the one bracket 254 and the upper portion 238a form a single, monolithic component, and the two brackets 254 and the lower portion 238b form a single, monolithic component. The lower portion 238b also includes a mounting aperture 262 adjacent the bottom wall 242 and the flange portion 252. The mounting aperture 262 is configured to receive a fastener to couple to shroud 238 to the housing 14.

The illustrated shroud 238 also includes a debris port 243. The debris port 243 extends from the outer wall 239 in a direction away from the chainsaw housing 14. In the illustrated embodiment, the debris port 243 is integrally formed as a single piece with the lower portion 238b. Stated another way, the debris port 243 and the lower portion 238b form a single, monolithic component. In some embodiments, the debris port 243 may be a separate piece that is coupled to a wall (e.g., the outer wall 239) of the lower portion 238b. In the illustrated embodiment, the debris port 243 extends perpendicularly from the outer wall 239. In some embodiments, the debris port 243 may extend in other directions from the outer wall 239. For example, the debris port 243 may extend obliquely from the outer wall 239. In the illustrated embodiment, the debris port 243 extends from a bottom rear corner of the shroud 238 (i.e., adjacent the rear wall 240 and the bottom wall 242). In other embodiments, the debris port 243 can extend from other portions of the shroud 238. Positioning the debris port 243 in the bottom rear corner of the shroud 238 reduces interference of the debris port 243 (and a connected suction source or collection bag) with a work piece and/or user during operation of the chainsaw 10.

The shroud 238 is configured to be coupled to the chainsaw 10 in a similar orientation as the shrouds 38, 138. As such, the flange portion 252 is configured to be adjacent the guide bar 34, and the rear wall 240 is configured to be furthest from the guide bar 34. The top wall 241 is configured to be nearest the handle 26, and the bottom wall 242 is configured to be furthest from the handle 26.

Various features of the disclosure are set forth in the following claims.

What is claimed is:

1. A chainsaw comprising:
a housing;
a guide bar coupled to the housing;
a cutting chain disposed along the guide bar and configured to cut a workpiece and generate debris;
a shroud coupled to the housing, a portion of the guide bar disposed between the housing and the shroud; and
a connector coupled to the shroud and configured to receive the debris.

2. The chainsaw of claim 1, wherein the connector includes a first end coupled to the shroud and a second end opposite the first end and configured to be coupled to a suction source.

3. The chainsaw of claim 2, wherein the first end of the connector is captured between the shroud and the housing.

4. The chainsaw of claim 2, wherein the connector includes a flange extending outwardly from the first end, and wherein the flange engages the shroud.

5. The chainsaw of claim 4, wherein
the flange includes a pair of rounded corners and a pair of sharp corners opposite the pair of rounded corners,
the pair of rounded corners are positioned nearest the guide bar, and
the pair of sharp corners are positioned furthest from the guide bar.

6. The chainsaw of claim 2, wherein the first end has a polygonal shape, and wherein the second end has a circular shape.

7. The chainsaw of claim 2, wherein
the first end has a first opening defining a first area,
the second end has a second opening defining a second area, and
the first area is greater than the second area.

8. A chainsaw comprising:
a housing;
a guide bar coupled to the housing;
a cutting chain disposed along the guide bar and operable to cut a workpiece and generate debris; and
a shroud coupled to the housing and including a debris port, the debris port configured to receive the debris.

9. The chainsaw of claim 8, wherein the shroud includes
an outer wall,
a rear wall extending from the outer wall toward the housing,
a top wall extending from the outer wall toward the housing, and
a bottom wall extending from the outer wall toward the housing.

10. The chainsaw of claim 9, wherein each of the rear wall, the top wall, and the bottom wall engages the housing.

11. The chainsaw of claim 9, wherein the debris port is positioned adjacent the rear wall and the bottom wall.

12. The chainsaw of claim 9, wherein the debris port is integrally formed with the outer wall.

13. The chainsaw of claim 8, wherein the shroud includes an outer wall, and wherein the debris port extends obliquely from the outer wall in a direction away from the housing.

14. The chainsaw of claim 13, wherein the debris port also extends away from the guide bar.

15. The chainsaw of claim 8, wherein the shroud includes a plurality of ridges formed on an inner surface of the shroud and extending toward the housing.

16. The chainsaw of claim 8, wherein the debris port is configured to be coupled to a suction source.

17. The chainsaw of claim 8, wherein a portion of the guide bar is disposed between the housing and the shroud.

18. A shroud for use with a chainsaw, the chainsaw including a housing, a guide bar coupled to the housing, and a cutting chain disposed along the guide bar and operable to cut a workpiece and generate debris, the shroud comprising:
an outer wall configured to be spaced apart from the housing of the chainsaw and cover a portion of the guide bar;
a rear wall extending from the outer wall and configured to extend toward the housing;
a top wall extending from the outer wall and configured to extend toward the housing;
a bottom wall extending from the outer wall and configured to extend toward the housing; and
a debris port extending outwardly from the outer wall, the debris port configured to be coupled to a suction source.

19. The shroud of claim 18, wherein the debris port is integrally formed with the outer wall.

20. The shroud of claim 18, wherein the debris port extends obliquely from the outer wall.
